(19) United States
(12) Patent Application Publication
(10) Pub. No.: US 2005/0136915 A1
(43) Pub. Date: Jun. 23, 2005

(54) Multimedia messaging service arrangement and method

(75) Inventors: Michael Rooke, Hyvinkaa (FI); Jukka O. Raikkonen, Helsinki (FI); Teppo Savinen, Vihti (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/816,949

(22) Filed: Apr. 5, 2004

(30) Foreign Application Priority Data
Dec. 19, 2003 (FI) 20031871

(51) Int. Cl. H04Q 7/20

(52) U.S. Cl. 455/428; 455/433; 455/432.1

(57) ABSTRACT

A multimedia messaging service arrangement and a method in a telecommunications system are disclosed. The arrangement comprises a first system entity providing a multimedia messaging service to user equipment connected to a network of the system and a second system entity providing a value added service to a user of the user equipment via the multimedia messaging service. The first system entity is configured to send a message to the second system entity, wherein the message comprises roaming information on the user equipment (UE1, UE2).

### FIELD OF THE INVENTION

The present invention relates to a multimedia messaging service in a telecommunications system.

### BACKGROUND OF THE INVENTION

Multimedia Messaging Service (MMS) is a new kind of messaging service similar to Short Message Service (SMS) for the mobile environment, standardized by the Open Mobile Alliance (OMA, formerly known as the WAP Forum) and the 3rd Generation Partnership Program (3GPP). However, an MMS message may include audio and video content in addition to conventional text content. The MMS is bearer-independent, and therefore not limited to only e.g. GSM or WCDMA networks.

FIG. 1 shows a reference architecture of Multimedia Messaging Service Environment (MMSE) as specified by the 3GPP. An essential element of the MMS is a multimedia messaging service centre (MMSC). According to the reference architecture, the multimedia messaging service centre MMSC includes (either within MMSC or as external servers connected thereto either directly or through an IP network) an MMS Relay and a number of MMS servers. According to the established naming practice, server 0 is a message storage server while other servers 1 to N provide other services, such as e-mail, telefax services, etc. The MMS relay is connected to user databases, such as an HLR (Home Location Register).

The MMSE provides the multimedia messaging services to user equipment, e.g. a mobile station, via one or more access networks to which the user equipment (UE) is connected. A UE comprises or is connected to an MMS User Agent, which is an application layer function that provides the users with the ability to view, compose and handle multimedia messages (MM). In FIG. 1 first user equipment UE1 is connected to the MMSC through an access network A, which is the home network of UE1. Roaming user equipment UE2 in turn is connected to the MMSC through a visited network B.

An MMS Value Added Service (VAS) Application, also shown in the architecture of FIG. 1, offers value added services to MMS users via the MMS. There may be several MMS VAS applications included in or connected to an MMSE. The VAS applications can be connected to the MMSC either directly, as shown in FIG. 1, or e.g. via an IP network. A value added service generally refers to a telecommunication service by means of which the user is provided with a service outside the telecommunication network. Value added services include e.g. various information services, interactive gaming and personal multimedia communication services. Value added services could be provided either by the operator or a 3rd party.

### BRIEF DESCRIPTION OF THE INVENTION

An object of the present invention is to provide an enhanced multimedia messaging service apparatus and method. The objects of the invention are achieved by a multimedia messaging service arrangement, a method, a telecommunications system element, a value added service providing element and a computer-readable storage medium comprising a computer program set, which are characterized by what is stated in the independent claims 1, 19, 37, 45 and 60. The preferred embodiments of the invention are disclosed in the dependent claims.

The invention is based on the realization that by providing an MMS VAS application with roaming information on user equipment, the roaming of the user equipment can be taken into account by the VAS providing system entity when providing a value added service to the user equipment. The MMS VAS application generally refers to a system entity providing a value added service to a user of the user equipment via a multimedia messaging service in a multimedia messaging service system. The invention is further based on providing the VAS providing system entity with the roaming information on the user equipment by sending a message from a system entity, which provides the multimedia messaging service to the user equipment, to the VAS providing system entity, which message comprises the roaming information on the user equipment.

An advantage of the arrangement and method of the invention is that it provides the VAS applications with a possibility of taking into consideration the roaming information on the user equipment and of using the roaming information when providing a value added service to the user equipment, e.g. by producing a value added service dependently or conditionally on the roaming information value. An indication of roaming can be very useful for external applications that are able to perform content adaptation: with the knowledge that the user equipment is roaming the content may be adapted e.g. such that the transfer time and hence the costs incurred are lower. Furthermore, an indication of roaming could also be used to perform specific actions, e.g. routing or forwarding the multimedia message in a roaming situation to another destination that provides a higher transfer bandwidth.

### BRIEF DESCRIPTION OF THE DRAWINGS

In the following the invention will be described in greater detail by means of preferred embodiments with reference to the attached drawings, in which

FIG. 1 is a block diagram of a telecommunications system in which the invention can be used;

FIG. 2 is a signalling diagram of an embodiment of the invention; and

FIG. 3 is a signalling diagram of an embodiment of the invention.

### DETAILED DESCRIPTION OF THE INVENTION

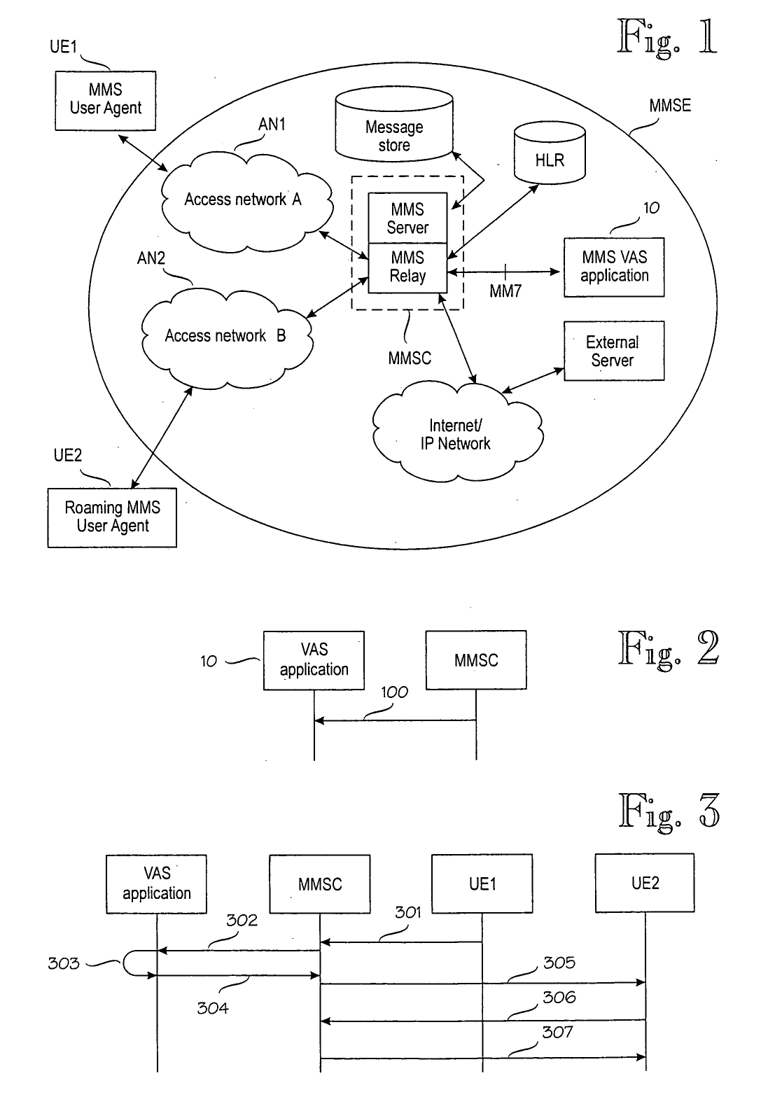

FIG. 1 illustrates a block diagram of a telecommunications system in which the invention can be used. As already described earlier, the system of FIG. 1 is the reference architecture of multimedia messaging service environment (MMSE) as specified by the 3GPP. As to a more detailed functional description of the multimedia messaging service, reference is made to 3GPP Technical Specification 23.140 V6.3.0 (September, 2003): “3rd Generation Partnership Project; Technical Specification Group Terminals; Multimedia Messaging Service (MMS); Functional description; Stage 2 (Release 6)”. The use of the invention, however, is by no means limited to the system shown in FIG. 1 but the invention can also be used in other kind of present and future multimedia messaging systems. It should also be noted that FIG. 1 illustrates only elements that are necessary for the understanding of the invention. Also the terminology used should be interpreted broadly and understood as descriptive and not limiting.

The system of FIG. 1 comprises a multimedia messaging service centre (MMSC), which typically includes (either within MMSC or as external servers connected thereto either directly or through an IP network) an MMS Relay and a number of MMS servers. The functions of the MMS relay and MMS server(s) may also be combined within the multimedia messaging service centre such that they do not appear as separate entities. It should be noted that the multimedia messaging service environment might comprise more than one multimedia messaging service centre, which may be used in a clustered manner. This, however, has no relevance to the basic idea of the invention. The MMS relay is connected to user databases, such as an HLR (Home Location Register). The MMSE provides the multimedia messaging services to user equipment UE1 and UE2, e.g. a mobile station or a fixed network terminal, via one or more access networks AN1 and AN2 to which the user equipment (UE) is connected. The access networks AN1 and AN2 can be e.g. second generation mobile networks, such as GSM or CDMA networks, and/or third generation mobile networks, such as UMTS networks. The access networks AN1 and AN2 can also include other cellular networks, fixed networks and IP networks. A UE comprises or is connected to an MMS User Agent, which is an application layer function that provides the users (not shown separately) with the ability to view, compose and handle multimedia messages (MM). In FIG. 1 first user equipment UE1 is connected to the MMSC through an access network A (AN1), which is the home network of UE1. Roaming user equipment UE2 in turn is connected to the MMSC through a visited network B (AN2). Furthermore, FIG. 1 shows an MMS Value Added Service (VAS) Application 10, which offers value added services to MMS users via the MMS. Value added services could be provided either by the operator or a 3rd party. There may be one or several MMS VAS applications 10 included in or connected to an MMSE. The VAS applications 10 can be connected to the MMSC either directly, as shown in FIG. 1, or e.g. via an IP network. The VAS applications may be physically located in a special server element or some other network element, for example. This, however, has no relevance to the basic idea of the invention. According to 3GPP specifications, the reference point (or interface) between the MMSC and an MMS VAS Application 10 is MM7.

According to the invention, an MMS VAS application 10, i.e. a system entity providing a value added service to a user of a user equipment UE1 or UE2 via the multimedia messaging service, is provided with roaming information on the user equipment UE1 or UE2 by sending a message 100 from a system entity, which provides the multimedia messaging service to the user equipment, to the VAS providing system entity, which message comprises the roaming information on the user equipment. In the exemplary system of FIG. 1, the system entity, which provides the multimedia messaging service to the user equipment UE1 or UE2, is the MMSC. FIG. 2 illustrates a signalling diagram in which the MMSC sends a message 100 to the VAS application. The message 100, which is used for conveying the roaming information, is preferably an existing MM7 message, such as an MM7 delivery request message (MM7_deliver.REQ) or an MM7 delivery report request message (MM7_delivery_report.REQ), to which the required information is added. However, also a specific dedicated message could be used for conveying the roaming information. The roaming information preferably comprises a roaming status, which indicates if the user equipment UE1 or UE2 is roaming outside a home network of the user equipment, i.e. is roaming in a visited network. According to an embodiment of the invention, additional/alternative information, such as an address of a switching centre, which the user equipment is using, may be included in the roaming information conveyed in the message 100. The switching centre generally refers to e.g. a mobile switching centre MSC (not shown in the figures), which is a mobile network element performing the switching functions in its area of operation and controlling the interworking with other networks. The user equipment is typically connected to a mobile switching centre via a base station system (not shown in the figures), which provides an air interface for the user equipment.

The message 100, which is used for conveying the roaming information, preferably comprises a special roaming status element. For example, the XML (eXtensible Markup Language) Schema code of MM7 delivery request message as found in 3GPP Technical Specification 23.140 V6.3.0 is as follows:

```
<xs:complexType name=“deliverReqType”>
    <xs:complexContent>
      <xs:extension base=“tns:genericRSReqType”>
            <xs:sequence>
```

| | |
|---|---|
| <xs:element | name=“LinkedID” |

type=“tns:messageIDType” minOccurs=“0”/>

| | |
|---|---|
| <xs:element | name=“Sender” |

type=“tns:addressType”/>

| | |
|---|---|
| <xs:element | name=“Recipients” |

type=“tns:recipientsType” minOccurs=“0”/>

| | |
|---|---|
| <xs:element | name=“Previouslysentby” |

type=“tns:previouslySentByType” minOccurs=“0”/>

<xs:element

name=“Previouslysentdateandtime” type=
”tns:previouslySentByDateTime”
minOccurs=“0”/>

| | |
|---|---|
| <xs:element | name=“SenderSPI” |

type=“tns:serviceProviderIDType” minOccurs=“0”/>

| | |
|---|---|
| <xs:element | name=“RecipientSPI” |

type=“tns:serviceProviderIDType” minOccurs=“0”/>

| | |
|---|---|
| <xs:element | name=“TimeStamp” |

type=“xs:dateTime” minOccurs=“0”/>

| | |
|---|---|
| <xs:element | name=“ReplyChargingID” |

type=“tns:messageIDType” minOccurs=“0”/>

| | |
|---|---|
| <xs:element | name=“Priority” |

type=“tns:priorityType” minOccurs=“0”/>

| | |
|---|---|
| <xs:element | name=“Subject” |

type=“xs:string” minOccurs=“0”/>

| | |
|---|---|
| <xs:element | name=“Content” |

```
type=“tns:contentReferenceType” minOccurs=“0”/>
            </xs:sequence>
      </xs:extension>
    </xs:complexContent>
</xs:complexType>
```

As an example, the invention can be implemented by modifying this Schema to add the following roaming elements (or only one of them): a boolean flag indicating the roaming state (true or false) and the actual roaming MSC Address. An example of the possible modifications is shown below:

```
<xs:element name=“RoamingStatus”>
    <xs:complexType>
      <xs:attribute name=“Roaming” type=“xs:boolean” use=“optional”
default=“false”/>
      <xs:attribute name=“MSCAddress” type=“xs:string” use=“optional”
/>
    </xs:complexType>
</xs:element>
```

Both items (the flag and the address) are preferably optional. In this case the MMSC preferably decides when to use the roaming status indication and/or address information. This can be implemented e.g. such that a special pre-condition is set in the MMSC and when this pre-condition is met, the MMSC inserts the roaming information in the message 100 (or sends the message 100 if a dedicated message is used for this purpose). Such a precondition may be, for example, the country code of the MSC address of the user equipment; if the country code is different than that of the home operator of the user equipment, then the MSC address is not local to the operator and, consequently, the user equipment is roaming. It is also possible that the VAS application 10 asks for the roaming information. This embodiment is useful e.g. in a situation where the VAS application provides e.g. a push service to the user equipment. Push service refers to a telecommunication service by means of which a user equipment user is sent information, such as daily news, without a separate request for a single transmission. In other words, the transmission of one or more multimedia messages containing the information relating to the push service is initiated by the VAS application. In this situation, it is preferable that the VAS application asks for the roaming information on its own initiative before the transmission, since the roaming information possibly contained in the VAS application might be outdated.

The roaming information on the user equipment is typically readily available in the MMSC. In particular, in a mobile terminated message case the MMSC will typically request/perform a number lookup for user B. This is carried out via an IMSI (International Mobile Subscriber Identity) request to the HLR and this, as a side effect, will also return the current MSC address where the user equipment is. From this kind of location information the MMSC knows if the user equipment is roaming and can determine the corresponding roaming information, e.g. the roaming status indication and/or the address information (which in turn may comprise the complete address of the switching centre, which the user equipment is using, or just a country code of the network, which the user equipment is using, for example) and insert it into the message 100 to the VAS application. The HLR may alternatively upon request provide the MMSC with other information on the location of the user equipment, such as a VLR (Visitor Location Register) address where the subscriber is located. The VLR address according to e.g. the E.164 addressing standard is a globally unique number and comprises a country code, which can be used to identify in what country the user is located. From this the MMSC can then determine the corresponding roaming information and insert it into the message 100 to the VAS application. It is also possible that the MMSC determines the roaming information differently or from a different network element than the HLR without this having any relevance to the basic idea of the invention.

According to further embodiments of the invention, the roaming of the user equipment is taken into account by the VAS application and the roaming status information is used when providing a value added service to the user equipment, e.g. by producing a value added service dependently (i.e. how the service is produced) or conditionally (i.e. is the service produced or not) on the roaming information value. It should be noted that numerous other ways of using the roaming information in the VAS application may exist in addition to those presented in the following and the invention is not limited to only these examples. According to an embodiment of the invention, the VAS application adapts content of one or more multimedia messages to be delivered to the user equipment in response to an indication that the user equipment is roaming. Such one or more multimedia messages to be delivered to the user equipment may be originally generated by the VAS application. Alternatively, one or more multimedia messages to be delivered to the user equipment may be generated by some other entity such that the VAS application merely performs e.g. the possible content adaptation for multimedia messages that are delivered to the user equipment through the VAS application. The content adaptation may include, for example, reducing the size of the content, which is transferred to the user equipment, such that the transfer time and hence the costs incurred are lower or decrypting an encrypted content if the user equipment is roaming in an area where encrypted messages are not allowed. The content adaptation may also include adding an operator logo or an advertisement to the message. In this case the operator may decide to use a local pricing tariff for messages delivered to roaming user equipment and then gain revenue by adding advertisements or other information to these messages.

As an example, lets assume that UE1 in FIG. 1 is local in a home network AN1 and UE2 is also a customer of network AN1 but is currently roaming in a foreign network AN2.

1) UE1 sends a multimedia message that has DRM (Digital Rights Management, which is a rights management system, which ensures that content can only be used when the relevant conditions, determined by the copyright owner, have been met) applied to it and encryption is not allowed in the particular foreign network AN2. In this case, when the message arrives in the home operator's MMSC, the message must be sent to UE2 in plain text. This kind of decryption can be performed in the VAS application 10.

2) UE1 sends a message with a large message size to UE2. Here the transfer from UE1 via the VAS application 10 to UE2 can reduce the size of the message e.g. by replacing a complex image in the message with a thumbnail thereof. As a result, UE2 will not have to pay so much to retrieve the message.

FIG. 3 shows a general signaling diagram of the above content adaptation examples where the VAS application 10 performs filtering service (i.e. in these examples encryption removal or message size reduction). First UE1 sends 301 the multimedia message to the MMSC. Then the MMSC sends 302 the multimedia message and the roaming information to the VAS application e.g. in a MM7 delivery request message as described above. The VAS application 10 adapts 303 the content of the multimedia message and sends 304 it back to the MMSC. The MMSC notifies 305 UE2, and UE2 retrieves 306 and receives 307 the adapted multimedia message.

According to yet another embodiment of the invention, the VAS application 10 selects a route or a destination of one or more multimedia messages to be delivered to the user of the user equipment on the basis of the roaming status of the user equipment. For example, if the user equipment is roaming, the VAS application can direct a multimedia message, which is delivered through the VAS application or which is produced by the VAS application, to the user equipment via an alternative route or to another destination that provides a higher transfer bandwidth (e.g. the Internet via a fixed line) and from where the user of the user equipment can obtain it (e.g. to an e-mailbox of the user). According to an embodiment of the invention, the VAS application may defer the delivery of a multimedia message to the user equipment until a later time if the user equipment is roaming or decide not to deliver the multimedia message at all.

The VAS application 10 can also provide the user equipment with information on the basis of the roaming information. According to an embodiment of the invention, the VAS application determines a location of the user equipment on the basis of the address of the switching centre which the user equipment is using and provide the user equipment with information relating to the determined location. The information relating to the location may be e.g. local news. In a similar manner, a multimedia message may comprise charging information indicating e.g. which party is expected to be charged for e.g. a multimedia message submitted by the VAS application or for a reply message thereto. This kind of charging information may indicate, for example, that the service is free of charge to the user of the user equipment. This charging information may then be set by the VAS application depending on the roaming information.

It will be obvious to a person skilled in the art that, as the technology advances, the inventive concept can be implemented in various ways. The invention and its embodiments are not limited to the examples described above but may vary within the scope of the claims.

1. A multimedia messaging service arrangement in a telecommunications system, the arrangement comprising:
a first system entity providing a multimedia messaging service to user equipment connected to a network of a system; and
a second system entity providing a value added service to a user of the user equipment via the multimedia messaging service, wherein
the first system entity is configured to send a message to the second system entity, in which the message comprises roaming information on the user equipment.

2. The arrangement of claim 1, wherein the roaming information comprises a roaming status indicating if the user equipment is roaming outside a home network of the user equipment.

3. The arrangement of claim 1, wherein the roaming information comprises an address of a switching centre which the user equipment is using.

4. The arrangement of claim 1, wherein the second system entity is configured to use the roaming information when providing a value added service to the user equipment.

5. The arrangement of claim 4, wherein the second system entity is configured to adapt, on the basis of the roaming information, content of at least one multimedia message to be delivered to the user equipment.

6. The arrangement of claim 5, wherein the second system entity is configured to encrypt or decrypt at least part of the content of the at least one multimedia message to be delivered to the user equipment according to the roaming information.

7. The arrangement of claim 6, wherein the second system entity is configured to perform the encryption or decryption by using digital rights management.

8. The arrangement of claim 4, wherein the second system entity is configured to determine, on the basis of the roaming information, whether the value added service is providable to the user equipment.

9. The arrangement of claim 4, wherein the second system entity is configured to select a route or a destination of at least one multimedia message to be delivered to the user of the user equipment according to the roaming information.

10. The arrangement of claim 3, wherein the second system entity is configured to determine a location of the user equipment according to the address of the switching centre which the user equipment is using and provide the user equipment with information relating to the determined location.

11. The arrangement of claim 4, wherein the second system entity is configured to determine charging related information according to the roaming information and to add the charging related information to at least one multimedia message to be delivered to the user equipment.

12. The arrangement of claim 1, wherein the first system entity is configured to send the message comprising the roaming information on the user equipment to the second system entity in response to a request received from the second system entity.

13. The arrangement of claim 1, wherein the first system entity is configured to obtain information on a location of the user equipment from another system entity and to determine the roaming information on the user equipment according to the obtained location information before sending the message comprising the roaming information on the user equipment to the second system entity.

14. The arrangement of claim 1, wherein the message comprising the roaming information on the user equipment is an MM7 interface message.

15. The arrangement of claim 14, wherein the message comprising the roaming information on the user equipment is an MM7 delivery request message or an MM7 delivery report request message.

16. The arrangement of claim 1, wherein the first system entity comprises a multimedia messaging service centre.

17. The arrangement of claim 1, wherein the second system entity comprises a multimedia messaging service value added service application.

18. The arrangement of claim 1, wherein the user equipment comprises a mobile station.

19. A method for providing a multimedia messaging service in a telecommunications system comprising a first system entity providing multimedia messaging service to a user equipment connected to a network of the system, and a second system entity providing a value added service to a user of the user equipment via the multimedia messaging service, the method comprising:
sending a message from the first system entity to the second system entity, wherein the message comprises roaming information on user equipment.

20. The method of claim 19, wherein the sending step comprises sending the message comprising roaming information, in which the roaming information comprises a roaming status indicating if the user equipment is roaming outside a home network of the user equipment.

21. The method of claim 19, wherein the sending step comprises sending the message comprising roaming information, in which the roaming information comprises an address of a switching centre which the user equipment is using.

22. The method of claim 19, further comprising using the roaming information when providing a value added service to the user equipment.

23. The method of claim 22, further comprising adapting, in the second system entity, content of at least one multimedia message to be delivered to the user equipment according to the roaming information.

24. The method of claim 22, further comprising encrypting at least part of content of at least one multimedia message to be delivered to the user equipment according to the roaming information.

25. The method of claim 24, wherein the encryption is performed by using digital rights management.

26. The method of claim 22, further comprising determining, whether a value added service is providable to the user equipment according to the roaming information.

27. The method of claim 22, further comprising selecting, in the second system entity, a route or a destination of at least one multimedia message to be delivered to a user of the user equipment according to the roaming information.

28. The method of claim 21, further comprising determining, in the second system entity, a location of the user equipment according to the address of the switching centre which the user equipment is using; and providing the user equipment with information relating to the determined location.

29. The method of claim 22, further comprising determining charging related information according to the roaming information; and adding the charging related information to at least one multimedia message to be delivered to the user equipment.

30. The method of claim 19, further comprising sending the message, which comprises the roaming information on the user equipment, from the first system entity to the second system entity in response to a request received in the first system entity from the second system entity.

31. The method of claim 19, further comprising;
obtaining information on a location of the user equipment from another system entity than the first system entity; and
determining the roaming information on the user equipment according to the obtained location information before sending the message comprising the roaming information on the user equipment from the first system entity to the second system entity.

32. The method of claim 19, wherein the sending step comprises sending the message, in which the message comprising the roaming information on the user equipment is an MM7 interface message.

33. The method of claim 32, wherein the sending step comprises sending the message, in which the message comprising the roaming information on the user equipment is an MM7 delivery request message or an MM7 delivery report request message.

34. The method of claim 19, wherein the sending step comprises sending the message from the first system entity, in which the first system entity comprises a multimedia messaging service centre.

35. The method of claim 19, wherein the sending step comprises sending the message to the second system entity, in which the second system entity comprises a multimedia messaging service value added service application.

36. The method of claim 19, wherein the sending step comprises sending the message comprising the roaming information on the user equipment, in which the user equipment is a mobile station.

37. A telecommunications system element comprising:
providing means for providing multimedia messaging service to user equipment connected to a network; and
sending means for sending a message to a system entity providing a value added service to a user of the user equipment via the multimedia messaging service, wherein the message comprises roaming information on the user equipment.

38. The telecommunications system element of claim 37, wherein the roaming information comprises a roaming status indicating if the user equipment is roaming outside a home network of the user equipment.

39. The telecommunications system element of claim 37, wherein the roaming information comprises an address of a switching centre which the user equipment is using.

40. The telecommunications system element of claim 37, wherein the sending means sends the message comprising the roaming information on the user equipment to the system entity providing the value added service in response to a request received from the system entity providing the value added service.

41. The telecommunications system element of claim 37, further comprising obtaining means for obtaining information on a location of the user equipment from another system element and
determining the roaming information on the user equipment according to the obtained location information before sending the message comprising the roaming information on the user equipment to the system entity providing the value added service.

42. The telecommunications system element of claim 37, wherein the message comprising the roaming information on the user equipment is an MM7 interface message.

43. The telecommunications system element of claim 42, wherein the message comprising the roaming information on the user equipment is an MM7 delivery request message or an MM7 delivery report request message.

44. The telecommunications system element of claim 37, further comprising a multimedia messaging service centre.

45. A value added service providing element comprising:
providing means for providing a value added service to a user of user equipment connected to a network via a multimedia messaging service that is provided by a multimedia messaging service providing system entity; and
receiving means for receiving a message from the multimedia messaging service providing system entity, wherein the message comprises roaming information on the user equipment.

46. The value added service providing element of claim 45, wherein the roaming information comprises a roaming status indicating if the user equipment is roaming outside a home network of the user equipment.

47. The value added service providing element of claim 45, wherein the roaming information comprises an address of a switching centre, which the user equipment is using.

48. The value added service providing element of claim 45, further configured to use the roaming information when providing the value added service to the user equipment.

49. The value added service providing element of claim 48, further configured to adapt, content of at least one multimedia message to be delivered to the user equipment according to the roaming information.

50. The value added service providing element of claim 49, further configured to encrypt at least part of the content of at least one multimedia message to be delivered to the user equipment according to the roaming information.

51. The value added service providing element of claim 50, further configured to perform the encryption by using digital rights management.

52. The value added service providing element of claim 48, further configured to determine, whether the value added service is providable to the user equipment according to the roaming information.

53. The value added service providing element of claim 48, further configured to select a route or a destination of at least one multimedia message to be delivered to the user of the user equipment according to the roaming information.

54. The value added service providing element of claim 47, further configured to determine a location of the user equipment according to the address of the switching centre which the user equipment is using and provide the user equipment with information relating to the determined location.

55. The value added service providing element of claim 48, further configured to determine charging related information according to the roaming information and to add the charging related information to at least one multimedia message to be delivered to the user equipment.

56. The value added service providing element of claim 45, further configured to request the roaming information on the user equipment from the multimedia messaging service providing system entity.

57. The value added service providing element of claim 45, wherein the message comprising the roaming information on the user equipment is an MM7 interface message.

58. The value added service providing element of claim 57, wherein the message comprising the roaming information on the user equipment is an MM7 delivery request message or an MM7 delivery report request message.

59. The value added service providing element of claim 45, further comprising a multimedia messaging service value added service application.

60. A computer-readable storage medium comprising a computer program set,
wherein the execution of the program set in a computer connected to a telecommunications system causes the computer to execute steps, the steps comprising:
providing a value added service to a user of user equipment connected to a network of a telecommunications system via a multimedia messaging service, which is provided by a multimedia messaging service providing system entity; and
receiving a message from the multimedia messaging service providing system entity, wherein the message comprises roaming information on the user equipment.

61. The method of claim 22, further comprising decrypting at least part of content of at least one multimedia message to be delivered to the user equipment according to the roaming information.

62. The method of claim 61, wherein the decryption is performed by using digital rights management.

63. The value added service providing element of claim 49, further configured to decrypt at least part of the content of the at least one multimedia message to be delivered to the user equipment according to the roaming information.

64. The value added service providing element of claim 63, further configured to perform the decryption by using digital rights management.

65. A system for providing a multimedia message service in a telecommunications system comprising a first system entity providing multimedia messaging service to a user equipment connected to a network of the system, and a second system entity providing a value added service to a user of the user equipment via the multimedia messaging service, the system comprising:
sending means for sending a message from a first system entity to a second system entity, wherein the message comprises roaming information on user equipment.

66. A method for multimedia messaging comprising:
providing a multimedia messaging serviced to user equipment connected to network of a system;
providing a value added service to a user of the user equipment via the multimedia messaging service; and
sending a message from a first system entity to a second system entity, wherein the message comprises roaming information to the user equipment.
